(19) United States
(12) Patent Application Publication
(10) Pub. No.: US 2026/0259929 A1
(43) Pub. Date: Sep. 3, 2026

(54) XML DATA OUTPUT

(71) Applicant: FNV IP B.V., Leidschendam (NL)

(72) Inventor: Rene SCHMOHL, Leidschendam (NL)

(73) Assignee: FNV IP B.V., Leidschendam (NL)

(21) Appl. No.: 19/155,756

(22) PCT Filed: Feb. 12, 2024
(86) PCT No.: PCT/EP2024/053412

§ 371 Date: Aug. 12, 2025

(30) Foreign Application Priority Data
Feb. 13, 2023 (NL) 2034136

(51) Int. Cl. G06F 16/835

(52) U.S. Cl. CPC G06F 16/8373

(57) ABSTRACT

According to a first aspect of the present disclosure, there is provided a computer-implemented method of retrieving data from a database system as an XML document. The method comprises: receiving, a request to import an XML configuration file; importing, the XML configuration file; receiving, configuration information; populating the imported XML configuration file with the configuration information; and exporting, using the populated XML configuration file, data from a database system as an XML file. Unlocking insights from Geo-Data, the present invention further relates to improvements in sustainability and environmental developments: together we create a safe and liveable world.

### TECHNICAL FIELD

The disclosure relates to methods and systems for retrieving information from a database. More specifically, geodata is retrieved from a database system into XML without writing an XML file by hand. Unlocking insights from Geo-Data, the present invention further relates to improvements in sustainability and environmental developments: together we create a safe and liveable world.

### BACKGROUND

There is a general and ongoing need for systems and methods for determining sub-surface ground parameters. In particular, there is a need for systems and methods that can be used to model the properties of a target volume beneath the surface of the earth to provide information useful for infrastructure planning. There is also a need to determine sub-surface soil composition and structure. Determination of sub-surface ground properties in this manner during the early planning phase of construction projects reduces uncertainty during the location determination, foundation design, and construction phases of a project. This in turn reduces delays, overspend, and unnecessary use of material resources (e.g. concrete) during construction.

A variety of techniques can be used to ascertain the properties of a target sub-surface volume. These include down-hole and cross-hole techniques whereby one or more boreholes are drilled and soil samples obtained from the borehole are analysed. Other geological entities such as ground water wells can also be studied. Geological data (referred to herein as geodata) can also be obtained through seismology, from climate measurement stations and through a variety of other similar geological entities and investigations. Such geological study typically yields a large amount of geodata from a variety of sensors and data sources. Processing, storing and outputting such a large amount of geodata in a way that is computationally efficient, conforms with often complex and varying standards for representation of geodata, and is intuitively understandable to an analyst is problematic, due to the volume of data and the fact that data often comes from many different locations and data sources.

There is a need to provide improved mechanisms for processing, sorting, standardizing and outputting such geodata in a manner that is computationally efficient, conforms with standards for representation of geodata, and facilitates easy and intuitive understanding of data and comparison between data arising from different geological entities and data sources. As such, there is a need for changing the format or structure of data stored in a geodatabase system to make it readable and usable by a desired software. One such solution uses XML. XML stands for extensible Markup language and is designed to store and transport data. XML is often used for distributing data over the internet and may be in one of many different standards such as XML AJAX, XML DOM, XML XPath, XML XSLT, XML XQuery, XML DTD, XML Schema, XML Services. XML files are easily converted into other file formats. However, an author of an XML file must define both the tags and the document structure precisely in order for the XML document to be useable in post processing. This requires a user of the database to have a certain knowledge of programming in order to be able to convert data into a data format can be used by a desired system or application. Therefore, there is a need for a customizable process for producing XML files that places restraints on a user, thereby reducing the amount of programming knowledge required by the user.

### SUMMARY

According to a first aspect of the present disclosure, there is provided a computer-implemented method of retrieving data from a database system as an XML document. The database system may comprise one or more relational databases. The data may be geodata. “Geodata” in this context means geological data, in other words any form of data obtained through geological study pertaining to one or more properties of a sub-surface volume, particularly ground (e.g. soil, rock, water) characteristics. Geological data can be used in contexts such as borehole logs, well design, data sequence graphs and so on. The method comprises: receiving, a request to import an XML configuration file; importing, the XML configuration file; receiving, configuration information; populating the imported XML configuration file with the configuration information; and exporting, using the populated XML configuration file, data from a database system as an XML file. This enables a user to generate an XML file for distributing data. An XML file can be generated using data in geodatabases without explicitly programming into an XML file by implementing a customizable XML configuration file which assists in easily defining the structure of the XML export file. In some aspects the method further comprises receiving a target directory and providing the exported file to the target directory.

In some aspects, the XML configuration file may be imported from a library of existing XML configuration files. In some aspects, the XML configuration file may be created or edited by receiving an element name; receiving an attribute input corresponding to the element name; creating, in the XML configuration file, an element with an attribute based on the received element name and an attribute input corresponding to the element name. Sub-elements can be added to each element by receiving an attribute input corresponding to the sub-element name; creating, in the XML configuration file, a sub-element of the element, wherein the sub-element has a corresponding attribute, based on the received sub-element name and an attribute input corresponding to the sub-element name. The attribute input may comprise a namespace and the element or sub-element names may comprise a macro. This increases the flexibility and breadth of use of the XML configuration files. For example, the namespace of the ISO may be used as an attribute. For example, labelling instructions for labelling elements based on database tables can be provided as macros.

The configuration information may comprise: a template name; an object type; a file extension; and optionally a post processing indicator; and optionally a BOM indicator. This allows the user to specify XML format, object type and any post-processing preferences. The object type indicates the location of the database to be integrated for mark up. For example, an object may comprise one or more database tables and only rows and columns within the defined object are interrogated when exporting as the XML file. In some aspects, multiple object of the same object type may be exported as a zip file, the zip file comprising multiple files, each file corresponding to an object. In some aspects, a post processing step may occur after the export of the XML file. Post processing may comprise outputting a second file of a file type different to the exported XML file type. In some aspects, outputting a second file type different to the exported XML file type may comprise outputting both the XML file and the second file. In some aspects, outputting a second file type different to the exported XML file type may comprise discarding the XML file and only outputting the second file. In some aspects, XSLT is used to convert the XML file into the second file without programming input from a user.

According to another aspect of the present disclosure, there is provided a system comprising one or more processors and one or more memories having stored thereon computer-readable instructions configured to cause the one or more processors to perform any of the methods disclosed herein.

According to another aspect of the present disclosure, there is provided a computer-readable medium comprising instructions, that, when executed by one or more data processing apparatus, cause the one or more data processing apparatus to perform any of the methods disclosed herein.

According to another aspect of the present disclosure, there is provided a computer program comprising instructions which, when the program is executed by a computer, cause the computer to perform any of the methods disclosed herein.

### BRIEF DESCRIPTION OF THE DRAWINGS

Disclosed implementations will now be described by way of example to illustrate aspects of the disclosure and with reference to the accompanying drawings, in which

FIG. 1 shows schematically a system 100 that can be used to implement the disclosed methods;

FIG. 2 shows a method 200 of retrieving data from a database system as an XML document;

FIG. 3 shows a GUI from which the XML engine 116 receives configuration information;

FIG. 4 shows a method 400 of creating or editing an XML configuration file.

FIG. 5 shows a GUI from which the XML engine 116 receives elements and attribute information;

FIG. 6 shows an example of a section of an XML output file 600;

FIG. 7 shows a block diagram of one implementation of a computing device 700.

### DETAILED DESCRIPTION

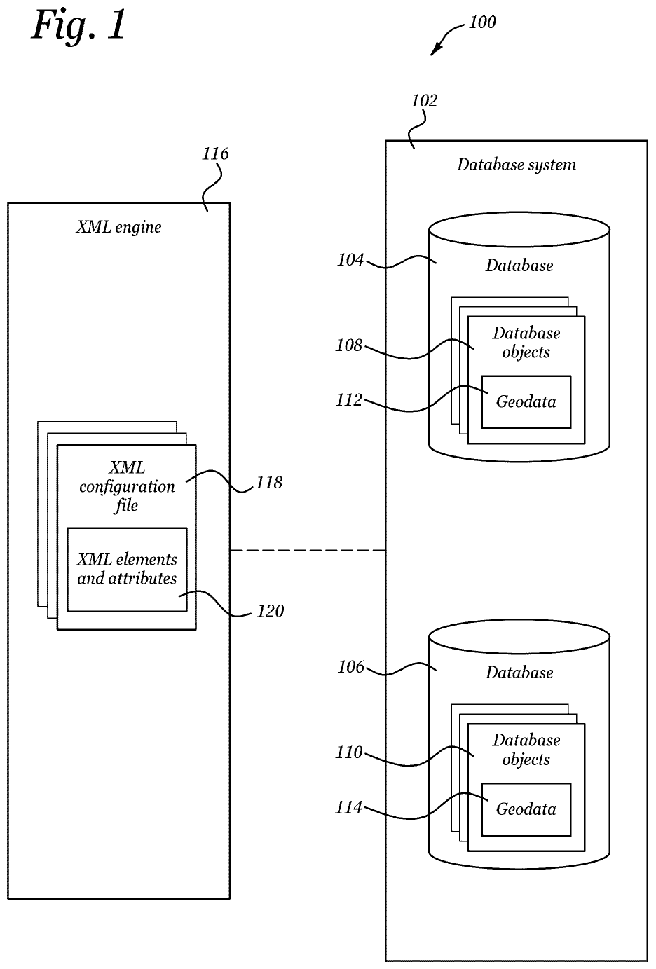

FIG. 1 shows a system 100 that can be used to implement the disclosed methods. The depicted database system 102 comprises one or more databases 104, 106. The one or more databases may be relational databases which are structured to recognize pre-defined relationships between stored data. For example, stored data may be stored in tables of columns and rows. The tables may make up one or more database objects 108, 110. A database object is a data structure used to store or reference data. A database object in the context of the present disclosure may comprise one or more tables of geodata 112, 114 associated with a particular geological entity, geological test, or geological experiment. The geodata 112, 114 in each database object 108, 110 may comprise data obtained from a plurality of data sources. For example, a particular example database object 108 may comprise a variety of geodata 112 relevant to a particular borehole. This borehole geodata may comprise data obtained through a variety of means and from a number of sources, represented in multiple tables, such as data obtained using a cone penetrometer test (CPT), data from lab or field-based experiments on soil samples taken from the borehole, seismology data obtained from or around the borehole, or data from any other suitable sensor or measuring device associated with the borehole in question. All this geodata for the borehole can then be grouped as one or more tables making up a database object 108 and stored within the database 104.

Other database objects 110 will similarly contain tables of geodata 114 associated with different respective geological entities. Geological entities may include boreholes, groundwater wells, climate measurement stations, soil containers, water containers or any other suitable entity, geological site or test from which geological data can be obtained. Geodata 112, 114 may accordingly contain any suitable data obtainable from such geological entities, including but not limited to borehole logs, general geological site data, soil sample data, pictures of the geological entity, data sequences (such as obtained through a CPT experiment), field and laboratory measurement data, well design data, groundwater data and so on. In some examples, a project may comprise multiple database objects 108, 110. In some examples, a database object is made up of one or more tables. It is of understood that a database object may be any appropriate way to store or reference any particular geological entity, geological test, or geological experiment. For example, instead of a collection of one or more tables, a database object may be, for example, a stored procedure, sequence, index, or view.

In order for two separate systems to exchange data, a file format must be agreed upon. XML standardizes this approach. Also shown in FIG. 1 is an XML engine 116. The XML engine 116 is configured to implement the methods disclosed herein, in order to retrieve geodata 112,114 from the data base system and export the data as an XML file. The XML file may be used for transmitting and reconstructing the data. The XML file may further be used in post-processing to convert the data into a different file type. The XML engine 116 and database system need not be co-located. For example, the XML engine 116 may be run on a user device and the database may be hosted on computer clusters, cloud storage or file systems on one or more different computing devices. The XML engine 116 comprises a plurality of configuration files 118 which can be configured to export the geodata 112, 114 as an XML file and optionally convert the XML file to a further file extension type in post-processing. The XML engine 116 may be configured retrieve geodata 112 from database objects 108 in database 104. A XML configuration file 118 may comprise a plurality of XML elements and corresponding attributes 120. An XML configuration file, also referred to herein as an XML template, is an exportable XML file format. The XML configuration file comprises instructions on which geodata 112, 114 to obtained from the database 104, 106 and instructions on how the XML file structure is to be configured.

The XML engine 116 may provide a suitable graphical user interface, GUI, configured to effectively display geodata. The GUI may also comprise a database object selection area comprising a list of database objects (e.g. database objects 108) available for selection. The GUI may be configured such that, in response to selection of a database object from the list of database objects, an option to export the data of the selected object as an XML file may be displayed.

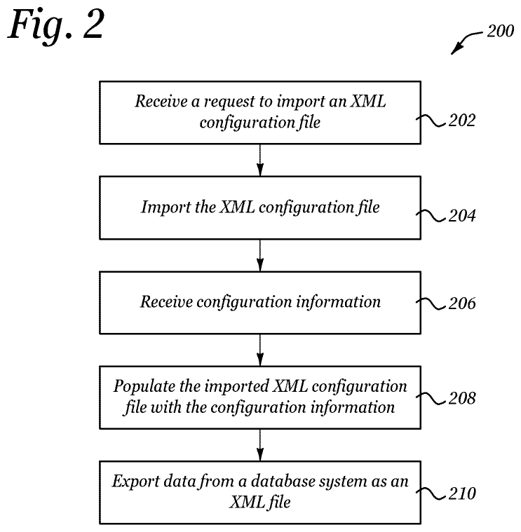

FIG. 2 shows a method 200 of retrieving data from a database system, such as the database system described above with reference to FIG. 1, as an XML file. The method 200 allows a user to select on or more tables in a database system 102 and export the data to a selected location as an XML file. The method is computer implemented and may be performed by the XML engine 116 described above with reference to FIG. 1.

At step 202, the XML engine 116 receives a request to import an XML configuration file 118. In response to this request, the XML engine 116 may provide an option to import an existing XML configuration file, edit an existing XML configuration file or create a new XML configuration file. For example, the XML configuration file may be an XML configuration file created according to the method 400 of creating or editing an XML configuration file described with reference to FIG. 4.

At step 204, the XML engine 116 imports the XML configuration file. Importing the XML configuration file may refer to any action where the XML configuration file is provided to the XML engine 116. For example, the XML configuration file may be created and then imported via a browser. In another example, the XML configuration file maybe be selected and imported via a browser. In another example, a library of XML configurations files may be stored in memory on a device running the XML engine 116 in which case importing the XML configuration file may just mean confirming that the configuration file is accessible by the XML engine 116.

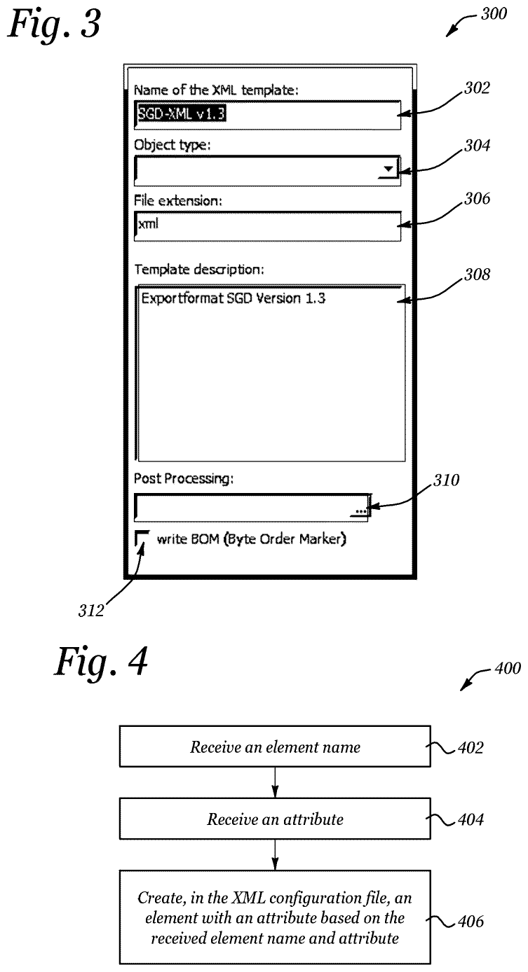

At step 206, the XML engine 116 receives configuration information. The configuration information may provide a data source, file type and name of the export generated from the configuration file and is shown in more detail with reference to FIG. 3. FIG. 3 shows a GUI from which the XML engine 116 receives configuration information. The configuration information comprises: a configuration file name, an object type, a file extension and, optionally, a post processing indicator and/or a BOM indicator.

The name of the configuration file is provided in field 302 of FIG. 3 as “SGD-XML v 1.3”. The provided name of the configuration file is used as a “display name” for the exported XML file. It should be noted that the terms XML configuration file 118 and XML template may both be used interchangeably in the present disclosure to refer to the tool with which a user may specifies the desired structure and data source of the XML file and optionally the post processing file they wish to output.

An object type of the data to be exported is provided in field 304. As described above with reference to FIG. 1, an object may describe one or more tables in a database system. For example, a database object in the context of the present disclosure may comprise one or more tables of geodata 112, 114 associated with a particular geological entity, geological test or geological experiment.

A file extension type is provided in field 306. The file extension type determines the file type of the XML file export. For example, the file extension type may be one of xml, kml, wl or gml. Of course, any appropriate file extension of the XML export may be supported.

Optionally, a description may be provided in field 308. The description may help a user distinguish between the XML configuration files 118. Optionally, a further format may be selected in a post processing field 310. This indicates a further format into which to convert the XML file exported in method 200. For example, in one embodiment, the post processing field 310 may be populated. For example, the post processing field 310 may be populated with a further file type to be generated in post-processing. Example file types include HTML, JSON, plain text, or XSL Formatting Objects, which may subsequently be converted to other formats, such as PDF, PostScript, RTF, Excel, CSV, .wl, BML and PNG. Of course, it should be understood that post-processing may be used to generate a file of any appropriate file type.

Optionally, a further write BOM (Byte Order Marker) field 312 may be used to write the order in which bytes are to be read. Field 312 may be required for postprocessing of the XML export providing in method 200.

At step 208, the XML engine 116 populates the XML configuration file based on the configuration information. In some examples, step 208 may further comprise selecting a file destination of the XML file to be exported. In some examples, populating the XML configuration file may comprise populating attributes and elements based on the object provided in the configuration information. In some examples, the elements and attributes may be populated using a namespace or a macro.

At step 210, the XML engine 116 exports, using the populated XML configuration file, data from a database system as an XML file. In some examples, multiple objects may be exported simultaneously. In some examples, a further format is selected in the post processing field 310. In such examples, the XML engine 116 performs additional processing on the exported XML in order to create an additional file of the file format specified in post processing field 310. In some examples, an XSLT stylesheet is provided as a file using a path field pointing to the file. This may be XSLT (Extensible Stylesheet Language Transformations) used for transforming the XML export file into other XML files or other formats such as HTML, JSON, plain text or XSL Formatting Objects, which may subsequently be converted to other formats, such as PDF, PostScript and PNG.

As discussed above with reference to FIG. 2, the XML configuration file 118 may be thought of as an exportable XML document format or template. When exported, one or more XML files are created using the format defined by the XML configuration file 118.

The XML configuration file 118 may be created according to a method 400 of creating or editing an XML configuration file described with reference to FIG. 4 by which the user may add elements or attributes 120 to the configuration file 118. Method 400 provides a constrained method for populating an XML configuration file that allows a user to define the elements and attributes without requiring knowledge of the format and syntax required to produce an XML file.

In some examples, the XML engine 116 may iteratively perform steps 402-406 in order to populate the XML configuration file with multiple elements and multiple attributes. In some examples, method 400 may be performed once, for example where an XML configuration file is edited to add an element or sub-element. It should be understood that the ordering of steps 402 and 404 is only illustrative that this ordering may be reversed. Furthermore, in other examples, such as when editing an XML configuration file only some of the steps in method 400 may be performed. It should be noted that the terms element, node and XML tag may be used interchangeably with the same meaning in the present disclosure. Similarly the terms sub-element and sub-node may also be used interchangeably to have the same meaning.

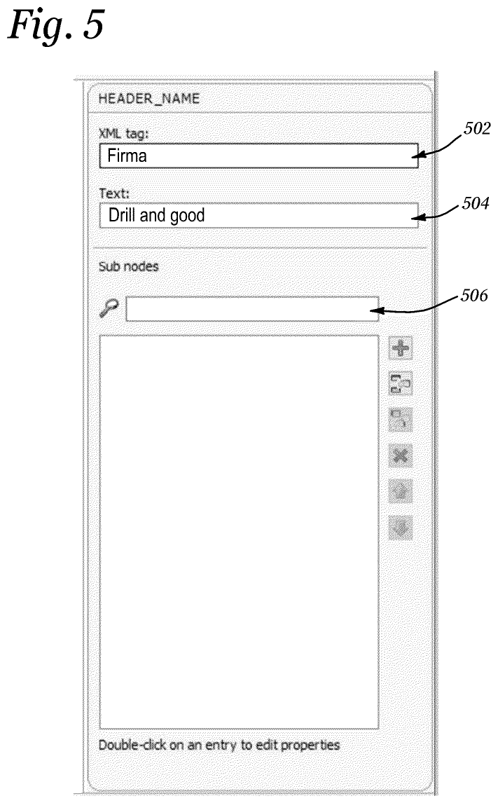

At step 402 the XML engine 116 receives an element name. FIG. 5 shows a GUI 500 from which the XML engine 116 receives elements and attribute information. For example, in field 502 of GUI 500, an element name “Firma” is provided.

At step 404 the XML engine 116 receives an element attribute. For examples in field 504 of GUI 500, an element attribute “Drill and good” is provided.

At step 406 the XML engine 116 creates in the XML configuration file an element with an attribute based on the received element name and an attribute input corresponding to the element name. For example, the resulting entry into an XML file using the above example is <Firma>Drill and good</Firma>.

Sub-elements may also be added using the steps 402-406 and are similarly received via GUI 500. For example sub-elements may be provided in field 506. In one example, sub elements “Firmenname”, “PLZ” and “Ort” may be provided in step 402. Sub-element attributes “Drill and good”, “12345” and “Oberberg” provided in steps 404 in order to produce the following entry in step 406:

```
<Firma>
  <Firmenname>Drill and good</Firmenname>
  <PLZ>12345</PLZ><
  Ort>Oberberg</PLZ>
</Firma>
```

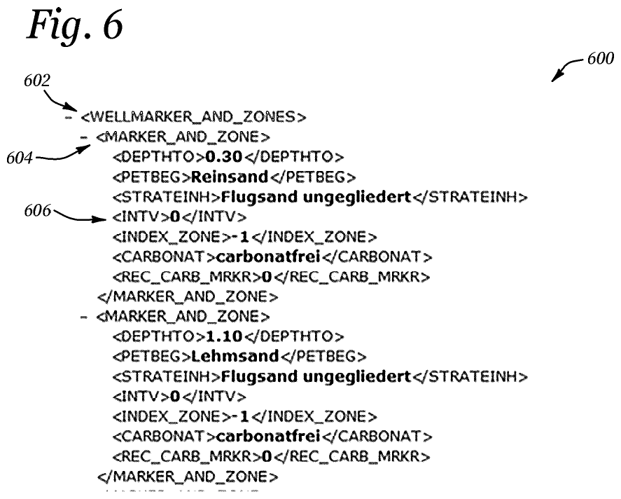

FIG. 6 shows another example of a section of an XML output file 600. As discussed above, an XML file such as shown in FIG. 6 is typically in the format<element>attribute</element>where the element may be a root element, an element or a sub element and all elements and attributes may be freely defined, for example, by the method 400 discussed with reference to FIG. 4. A root element is shown by 602. An element is shown by 604 and a sub-element is shown by 606.

Transformations may also be defined for elements. Transformations allow data to be pulled from the database and used to populate text within an XML file. In some examples a namespace may be provided as an attribute, for example, for an XML element “BoreholeModel”, a namespace of the ISO may be provided as an attribute as follows: <BoreholeModel xmlns: iso19155=″http://www.isotc211.org/iso19155/”></BoreholeModel>.

In some examples, an XML element may be defined as a macro in order for the element to be populated with data from a table in the database system. In some examples source tables and conditions for retrieving the data from the database system may be defined. This increases the flexibility and breadth of use of the XML configuration files as XML configuration files may be used on multiple different database objects provided they are of the same database type. As such, method 400 provides a constrained method for populating an XML configuration file that allows a user to define the elements and attributes without requiring knowledge of the format and syntax required to produce an XML file. Using the methods and systems described herein, a user may create their own XML configuration file for exporting data as XML for compliance with different software or standards without having to comply or have knowledge of the format constraints of producing an XML file.

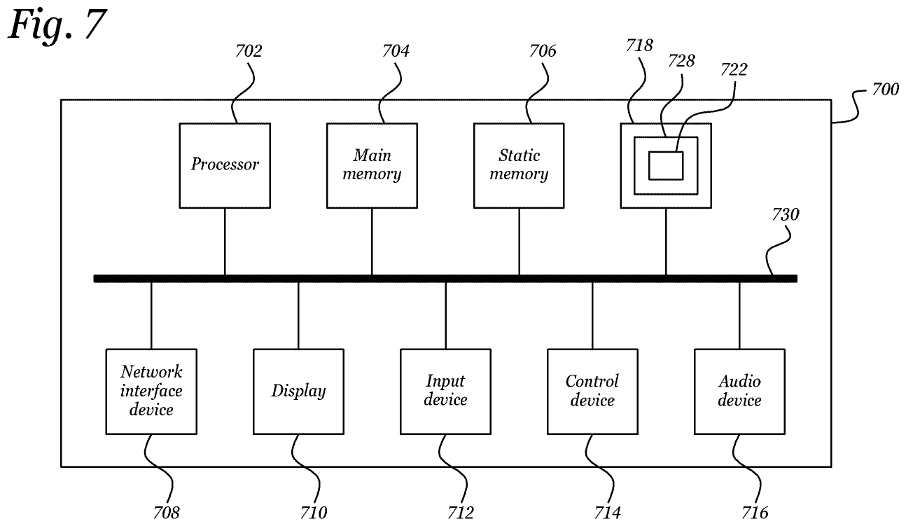

FIG. 7 shows a block diagram of one implementation of a computing device 700 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine.

Further, while only a single computing device is illustrated, the term “computing device” shall also be taken to include any collection of machines (e.g., computers) that individually or jointly execute a set (or multiple sets) of instructions to perform any one or more of the methodologies discussed herein. More particularly, a number of computing devices can be used to compute cross-correlations of signal data subsets independently and in parallel, as described above. Each computing device may have the structure shown in FIG. 16. Alternatively, a plurality of processors within a single computing device, such as computing device 700, can perform the independent computations.

The example computing device 700 includes a processor 702, a main memory 704 (e.g., read-only memory (ROM), flash memory, dynamic random-access memory (DRAM) such as synchronous DRAM (SDRAM) or Rambus DRAM (RDRAM), etc.), a static memory 706 (e.g., flash memory, static random-access memory (SRAM), etc.), and a secondary memory (e.g., a data storage device 718), which communicate with each other via a bus 730.

Processor 702 represents one or more general-purpose processors such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processors such as an application specific integrated circuit (ASIC), a field programmable gate array (FPGA), a digital signal processor (DSP), network processor, or the like. Processor 702 is configured to execute the processing logic (instructions 722) for performing the operations and steps discussed herein.

The computing device 700 may further include a network interface device 1608. The computing device 700 also may include a video display unit 710 (e.g., a liquid crystal display (LCD) or a cathode ray tube (CRT)), an alphanumeric input device 712 (e.g., a keyboard or touchscreen), a cursor control device 714 (e.g., a mouse or touchscreen), and an audio device 716 (e.g., a speaker).

It will be apparent that some features of computer device 700 shown in FIG. 7 may be absent. For example, one or more computing devices 700 may have no need for display device 710 (or any associated adapters). This may be the case, for example, for particular server-side computer apparatuses 700 which are used only for their processing capabilities and do not need to display information to users. Similarly, user input device 712 may not be required. In its simplest form, computing device 700 comprises processor 702 and memory 704.

The data storage device 718 may include one or more machine-readable storage media (or more specifically one or more non-transitory computer-readable storage media) 728 on which is stored one or more sets of instructions 722 embodying any one or more of the methodologies or functions described herein. The instructions 722 may also reside, completely or at least partially, within the main memory 704 and/or within the processor 702 during execution thereof by the computer system 700, the main memory 704 and the processor 702 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method of exporting data from a database system as an XML file, the method comprising:
receiving, a request to import an XML configuration file;
importing, the XML configuration file;
receiving, configuration information;
populating the imported XML configuration file with the configuration information; and
exporting, using the populated XML configuration file, data from a database system as an XML file.

2. The method of claim 1, wherein the configuration information comprises:
a template name;
an object type;
a file extension;
a post processing indicator; and
a BOM indicator.

3. The method of claim 1, wherein the XML configuration file is customizable.

4. The method of claim 1, wherein the XML configuration file is created by:
receiving an element name;
receiving an attribute input corresponding to the element name; and
creating, in the XML configuration file, an element with an attribute based on the received element name and an attribute input corresponding to the element name.

5. The method of claim 4, wherein creating the XML configuration file further comprises;
receiving an attribute input corresponding to the element name; and
creating, in the XML configuration file, a sub-element of the element, wherein the sub-element has a corresponding attribute, based on the received sub-element name and an attribute input corresponding to the sub-element name.

6. The method of claim 4, wherein the attribute input comprises a namespace.

7. The method of any of claim 4, wherein the element or sub-element name is received based on a macro.

8. The method of claim 1, wherein the configuration information defines an object and only tables and columns within the defined object are interrogated when exporting as the XML file.

9. The method of claim 1, further comprising a post processing step.

10. The method of claim 9, wherein the post processing step comprises outputting a second file of a file type different to a file type of the exported XML file.

11. The method of claim 10 wherein XSLT is used to convert the XML file into the second file.

12. The method of claim 1, further comprising:
receiving a target directory; and
providing the exported file to the target directory.

13. The method of claim 1, wherein multiple objects of a same object type are exported.

14. The method of claim 13, wherein the multiple objects are exported as a zip file, the zip file comprising multiple files, each file corresponding to an object.

15. A system comprising:
one or more processors; and
one or more memories having stored thereon computer-readable instructions which when executed cause the one or more processors to:
receive a request to import an XML configuration file;
import the XML configuration file;
receive configuration information;
populate the imported XML configuration file with the configuration information; and
export, using the populated XML configuration file, data from a database system as an XML file.

16. The system of claim 15, wherein the configuration information comprises:
a template name;
an object type;
a file extension;
a post processing indicator; and
a BOM indicator.

17. The system of claim 15, wherein the XML configuration file is customizable.

18. The system of claim 15, wherein the XML configuration file is created by:
receiving an element name;
receiving an attribute input corresponding to the element name; and
creating, in the XML configuration file, an element with an attribute based on the received element name and an attribute input corresponding to the element name.

19. The system of claim 18, wherein creating the XML configuration file further comprises:
receiving an attribute input corresponding to the element name; and
creating, in the XML configuration file, a sub-element of the element, wherein the sub-element has a corresponding attribute, based on the received sub-element name and an attribute input corresponding to the sub-element name.

20. The system of claim 18, wherein the attribute input comprises a namespace.
